(19) United States
(12) Patent Application Publication
(10) Pub. No.: US 2005/0004729 A1
(43) Pub. Date: Jan. 6, 2005

(54) Roll angle plausibility detection

(75) Inventors: Jeffrey D. Gleacher, West Bloomfield, MI (US); Ciprian D. Lucut, Satu Mare (RO); Robert M. Andres, Clarkston, MI (US); Andreas Knueppel, Pontiac, MI (US); Thomas J. Malbouef, Grosse Pointe, MI (US); Douglas A. McConnell, Rochester Hills, MI (US); Eric Mertz, Rochester, MI (US); Scott M. Morell, White Lake, MI (US)

Correspondence Address: SIEMENS CORPORATION;INTELLECTUAL PROPERTY LAW DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 10/877,495

(22) Filed: Jun. 25, 2004

Related U.S. Application Data
(60) Provisional application No. 60/483,341, filed on Jun. 27, 2003.

(51) Int. Cl. B60G 17/005

(52) U.S. Cl. 701/38; 280/5.502

(57) ABSTRACT

A vehicle safety system (20) includes a controller (24) that verifies the plausibility of a roll angle indication obtained by processing a roll angular rate sensor (26) output. The controller (24) determines whether an acceleration value corresponding to the roll angle indication is within an expected range. In a disclosed example, the controller (24) utilizes a vertical acceleration value and a first expected range and a lateral acceleration value and a second expected range. When both of the acceleration values are outside of the respective expected range, the controller determines that the roll angle indication is invalid.

### CROSS REFERENCE TO RELATED APPLICATIONS

This application claims priority to U.S. Provisional Application No. 60/483,341, which was filed on Jun. 27, 2003.

### FIELD OF THE INVENTION

This invention generally relates to vehicle safety systems. More particularly, this invention relates to detecting the plausibility of a roll angle indication.

### DESCRIPTION OF THE RELATED ART

Vehicle safety systems are well known. In many situations, supplemental restraint devices such as air bags are deployed under selected conditions. A controller onboard the vehicle monitors the driving conditions based upon sensor signals and decides when to deploy an airbag, for example. Various arrangements for detecting driving conditions are known.

One type of driving condition that can be addressed by many vehicle safety systems is a vehicle rollover. In many situations, a roll angular rate sensor provides an angular rate value that is integrated so that the safety system controller may make an appropriate determination for deploying a supplemental restraint device. There are various circumstances under which the processing of a roll angular rate sensor output indicates a vehicle rollover condition even though that is not the case. One example is an improper integration of the sensor output.

There is a need for the ability to determine whether a determined roll angle based on a roll angular rate sensor output does, in fact, accurately represent a rollover condition of the vehicle so that the safety system controller can take appropriate action. This invention addresses that need.

### SUMMARY OF THE INVENTION

An example disclosed method of processing a roll angular rate sensor output includes determining whether an acceleration value that corresponds to the roll angular rate sensor output is within an expected range. When the acceleration value is outside of the expected range, the roll angular rate sensor output can be considered invalid. In one example, a vertical acceleration value and a lateral acceleration value are considered. When both the vertical acceleration value and the lateral acceleration value are outside of the expected range, the roll angular rate sensor output is considered invalid.

An example device for processing vehicle rollover information is disclosed that includes a controller that determines whether a roll angle value is valid by determining whether a corresponding vehicle acceleration value is within an expected range. One example controller determines that the roll angle value is invalid if a vertical acceleration value is outside of an expected range and a lateral acceleration value is outside of an expected range. In one example, the expected range is determined based at least in part upon the magnitude of the roll angle value.

The disclosed arrangement provides a way to verify a roll angular rate sensor output based upon vehicle acceleration values. When the acceleration values do not correspond to a rollover condition as indicated by the roll angular rate sensor, the latter can be ignored.

The various features and advantages of this invention will become apparent to those skilled in the art from the following detailed description of a currently preferred embodiment. The drawings that accompany the detailed description can be briefly described as follows.

### BRIEF DESCRIPTION OF THE DRAWINGS

FIG. 1 schematically illustrates selected portions of a vehicle safety system designed according to an embodiment of this invention.

FIG. 2 is a flow chart diagram showing one example sensor output analysis.

FIG. 3 graphically illustrates an example expected range for a lateral acceleration value.

FIG. 4 graphically illustrates an example expected range for a vertical acceleration value.

FIG. 5 is a flow chart diagram showing an example sensor output processing approach that is useful with the embodiment of FIG. 2.

### DETAILED DESCRIPTION OF THE PREFERRED EMBODIMENT

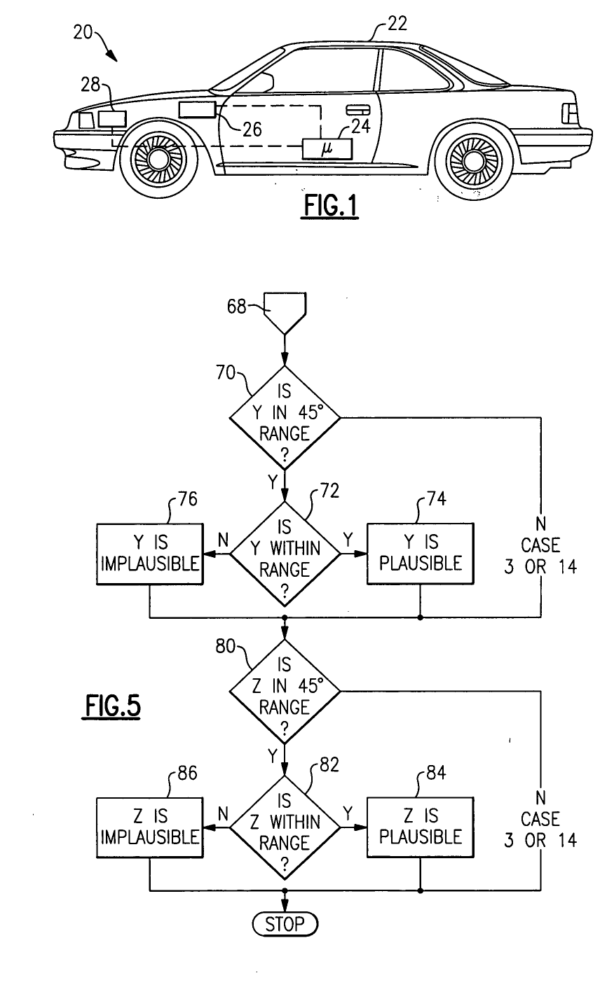

FIG. 1 schematically shows selected portions of a vehicle safety system 20 on board a vehicle 22. A controller 24 processes various sensor signals. In this example, a roll angular rate sensor 26 provides an angular rate output to the controller 24. The example controller 24 uses known techniques for obtaining a roll angle indication based on a signal from the roll angular rate sensor 26. In one example, the controller 24 integrates the angular rate output to determine a roll angle.

At least one acceleration sensor 28 provides an indication to the controller 24 regarding a vehicle vertical acceleration value and a vehicle lateral acceleration value. The sensors 26 and 28 are schematically shown for discussion purposes. Those skilled in the art who have the benefit of this description will realize how many sensor components will best meet the needs of their particular situation and where to locate such components on a particular vehicle.

The controller 24 utilizes the information from the acceleration sensor 28 for determining whether a determined roll angle, which is based at least in part on the output from the roll angular rate sensor 26, is plausible. In other words, the controller 24 determines whether a determined roll angle is plausible, given other vehicle condition indicators. In this way, the controller 24 confirms whether a roll angle determination based on the output from the roll angular rate sensor 26 is valid so that the controller 24 can then instigate appropriate action by an appropriate portion of the vehicle safety system 20.

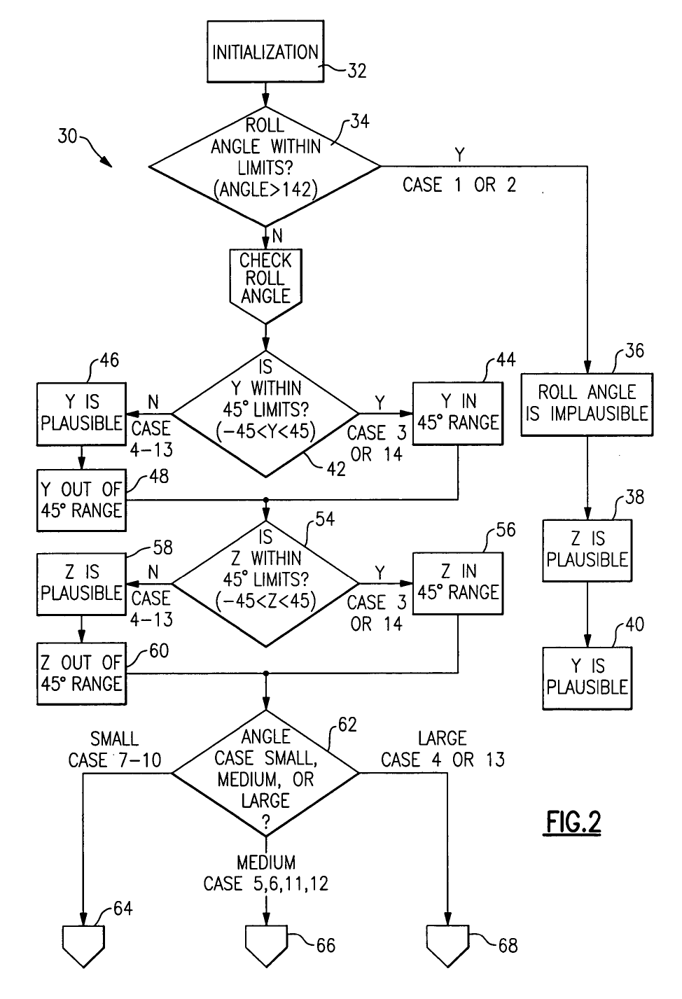

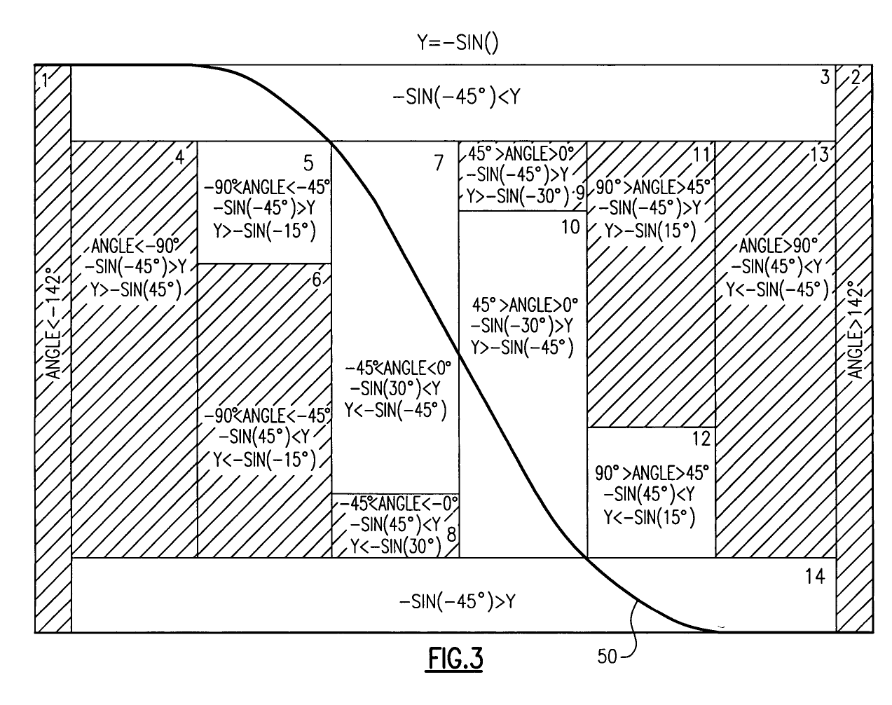

FIG. 2 is a flow chart diagram 30 that summarizes one example approach for the controller 24 to analyze the sensor outputs. The example process begins at 32. The roll angle indication is first checked to determine whether it is within a reasonable limit at 34. In this example, if the roll angle is less than −142° or greater than 142°, the roll angle is considered implausible at 36. At 38 the vertical acceleration value is labeled plausible and at 40 the lateral acceleration value is labeled plausible. In the example of FIG. 3, when the roll angle is less than −142°, that corresponds to the rectangular region labeled 1 and if the roll angle is greater than 142°, that corresponds to the rectangular region labeled 2. In either case, the roll angle is labeled as implausible at 36 in FIG. 2.

Referring to FIG. 3, an expected lateral acceleration value curve is shown at 50. FIG. 3 also shows an expected range for the lateral acceleration value. The expected range is shown in the rectangular regions labeled 3, 5, 7, 10, 12 and 14 in FIG. 3. If the lateral acceleration value is within one of the cross-hatched rectangles of FIG. 3, it is considered to be outside of the expected range.

If the roll angle value is less than 142°, the controller determines whether the lateral acceleration value is within a selected limit at 42. Considering the example of FIG. 3, the determination made at 42 corresponds to determining whether the lateral acceleration value fits within the regions labeled 3 or 14 as an initial check. If so, the lateral acceleration value is labeled as being within the 45° range at 44 in FIG. 2. If not, the lateral acceleration value is considered plausible at 46 and indicated as being outside of the 45° range at 48.

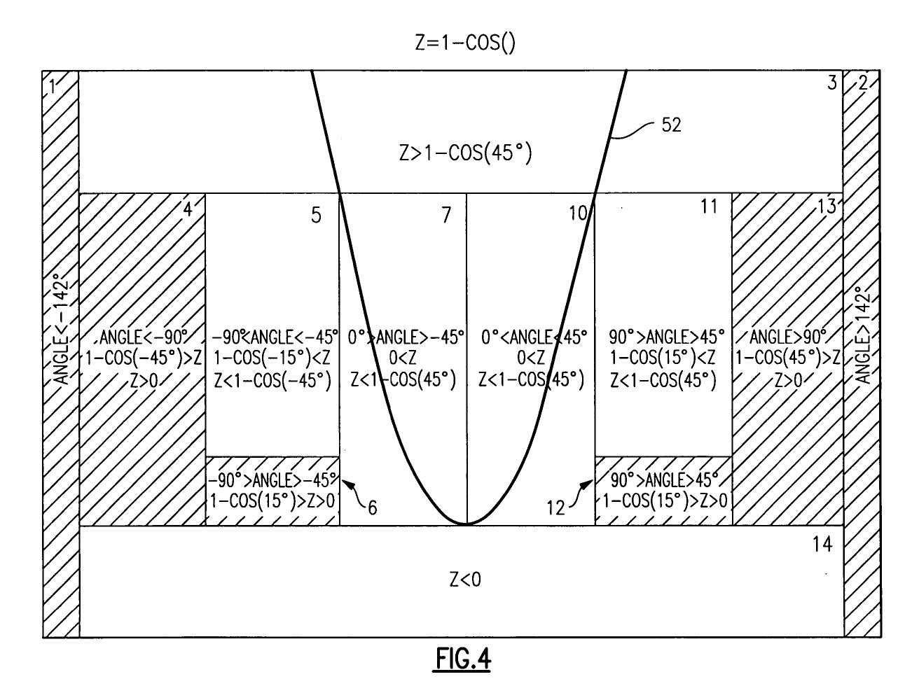

As can be appreciated from FIG. 2, the next step taken by the controller 24 in this example is to determine whether the vertical acceleration value is within an expected range. FIG. 4 graphically shows an expected vertical acceleration value curve at 52. The expected range for the vertical acceleration value is shown in the rectangular regions labeled 3, 5, 7, 10, 11 and 14 in FIG. 4. The cross-hatched rectangles indicate regions that are outside of the expected range.

In FIG. 2, at 54 the controller determines whether the vertical acceleration value is within 45° limits. In the event that the vertical acceleration value falls within one of the regions 3 or 14 from FIG. 4, the vertical acceleration value is labeled as being within the 45° range at 56. If not, the vertical acceleration value is labeled as plausible at 58 and the vertical acceleration value is labeled as being outside of the 45° range at 60.

At 62, the controller considers the roll angle magnitude and determines whether it is a small, medium or large angle. In one example, a small angle is any angle between 0° and 45°, a medium angle is between 45° and 90° and a large angle is anything between 90° and 142°. Depending on the magnitude of the roll angle, which is based on the roll angular rate sensor 26 output, the controller proceeds to determine whether the acceleration values are within an expected range at 64 in the case of a small angle, at 66 in the case of a medium angle and at 68 in the case of a large angle.

With the example ranges shown in FIGS. 3 and 4, the small angle analysis would include the regions 7, 8, 9 or 10; the medium angle analysis would include the regions labeled 5, 6, 11 and 12; and the large angle analysis would include the regions labeled 4 and 13.

FIG. 5 is a flow chart diagram summarizing the continuation of the analysis after the roll angle is labeled at 62. The first determination made at 70 in the example of FIG. 5 is whether the lateral acceleration was marked as being within the 45° range at 44. If not, the lateral acceleration value 50 fits within one of the rectangular regions 3 or 14 and the process continues as shown in the diagram.

In the event that the lateral acceleration value is within the 45° range, a determination is made at 72 whether the lateral acceleration value is within the rectangular regions 7 or 10, in which case the lateral acceleration value is labeled as plausible at 74. In the event that the lateral acceleration value fits within the rectangular regions 8 or 9, the lateral acceleration value is labeled as implausible at 76.

The vertical acceleration value is checked at 80. If the vertical acceleration value was marked as being within the 45° range at 56, the determination that the vertical acceleration value fits within the rectangular regions 3 or 14 of the expected range is already known. If not, a determination is made at 82 whether the vertical acceleration is within the expected range. Assuming that the roll angle magnitude was small (i.e., between −45° and 45°), the vertical acceleration value is necessarily within the range shown in the regions 7 or 10 of FIG. 4. Assuming that the roll angle were medium, a determination would be made whether the vertical acceleration value fits within the regions 5 or 11 and labeled plausible at 84 or whether it fits within the regions 6 or 12 such that the vertical acceleration value would be labeled as implausible at 86.

In the illustrated example, the expected range for the acceleration values is based upon a sine function and a range of angles for that sine function, which is selected based upon the magnitude of the roll angle. For example, the portion of the expected range for the lateral acceleration shown within the region 7 in FIG. 3 corresponds to the roll angle being between −45° and 0°. In that example, the relevant part of the expected range for the lateral acceleration value, which is labeled y in this example, corresponds to −SIN (30°)<y<−SIN (−45°). This is one example way of selecting the expected range. The other values shown in FIG. 3 and FIG. 4 correspond to the expected ranges of the disclosed example embodiment. Those skilled in the art who have the benefit of this description will be able to set appropriate range limits to meet the needs of their particular situation.

The controller 24 determines a roll angle based on the output from the sensor 26 and whether the vertical acceleration value and the lateral acceleration value fit within an expected range. In this example, the controller considers the roll angle, which is based on processing the roll angular rate sensor output, to be valid if it is within a plausible range (i.e., between −142° and 142°) and at least one of the vertical acceleration value or the lateral acceleration value is within an expected range. In the event that both the vertical acceleration value and the lateral acceleration value are outside of the expected range, then the controller 24 determines that the determined roll angle is invalid. Using the vertical acceleration value and lateral acceleration value as a check upon how the roll angular rate sensor output is processed (i.e., integrated) provides the ability to determine the plausibility of a roll angle determination before using that information for deploying a supplemental restraint device, for example.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1. A method of detecting a vehicle rollover condition, comprising:
determining whether an acceleration value corresponding to a determined roll angle based on a roll angular rate sensor output is within an expected range.

2. The method of claim 1, including determining that the determined roll angle is invalid when the acceleration value is outside of the expected range.

3. The method of claim 1, including determining whether a vertical acceleration value corresponding to the determined roll angle is within a first expected range and determining whether a lateral acceleration value corresponding to the determined roll angle is within a second expected range.

4. The method of claim 3, including determining that the determined roll angle is valid when the vertical acceleration value is within the first expected range or the lateral acceleration value is within the second range.

5. The method of claim 3, including determining that the determined roll angle is invalid when the vertical acceleration value is outside of the first range and the lateral acceleration value is outside of the second range.

6. The method of claim 3, including determining the first expected range based upon a cosine function of a selected range of angles related to the determined roll angle.

7. The method of claim 3, including determining the second expected range based upon a sine function of a selected range of angles related to the determined roll angle.

8. The method of claim 1, including determining a magnitude of the determined roll angle and determining the expected range based at least in part on the determined magnitude.

9. The method of claim 1, including integrating an output of the roll angular rate sensor output to thereby determine the roll angle.

10. A device for processing vehicle rollover information, comprising:
a controller that determines whether a roll angle value is valid by determining whether a corresponding vehicle acceleration value is within an expected range.

11. The device of claim 10, wherein the controller determines whether a vertical acceleration value is within a first expected range and a lateral acceleration value is within a second expected range.

12. The device of claim 11, wherein the controller determines that the roll angle value is invalid if the vertical acceleration value is outside of the first expected range and the lateral acceleration value is outside of the second expected range.

13. The device of claim 10, wherein the controller determines the expected range based at least in part on the magnitude of the roll angle value.

14. A system for detecting a rollover of a vehicle, comprising:
at least one roll angular rate sensor;
at least one acceleration sensor; and
a controller that determines a roll angle based on an output from the at least one roll angular rate sensor and determines whether the determined roll angle is valid by determining whether a corresponding output from the at least one acceleration sensor is within an expected range.

15. The system of claim 14, wherein the controller determines that the roll angle is invalid when the acceleration sensor output is outside of the expected range.

16. The system of claim 14, wherein the at least one acceleration sensor comprises a lateral acceleration sensor and a vertical acceleration sensor and the controller determines whether the lateral acceleration sensor output is within a first expected range and whether the vertical acceleration sensor output is within a second expected range.

17. The system of claim 16, wherein the controller determines that the roll angle is valid when the vertical acceleration sensor output is within the first expected range or the lateral acceleration sensor output is within the second range.

18. The system of claim 16, wherein the controller determines that the roll angle is invalid when the vertical acceleration sensor output is outside of the first range and the lateral acceleration sensor output is outside of the second range.

19. The system of claim 14, including determining a magnitude of the roll angle and determining the expected range based at least in part on the determined magnitude.

20. The system of claim 14, wherein the controller determines the roll angle based on an integration of an output from the roll angular rate sensor.
